(19) United States
(12) Patent Application Publication
(10) Pub. No.: US 2012/0323443 A1
(43) Pub. Date: Dec. 20, 2012

(54) Connecting Device for a Towed Vehicle, and Towed Vehicle Having a Connecting Device

(75) Inventors: Rainer Risse, Pattensen-Reden (DE); Axel Stender, Hameln (DE)

(73) Assignee: WABCO GMBH, Hannover (DE)

(21) Appl. No.: 13/581,827

(22) PCT Filed: Jan. 20, 2011
(86) PCT No.: PCT/EP2011/000223

§ 371 Date: Aug. 30, 2012

(30) Foreign Application Priority Data
Apr. 24, 2010 (DE) 10 2010 018 127.7

(51) Int. Cl. B60D 1/62

(52) U.S. Cl. 701/36

(57) ABSTRACT

The invention relates to a connecting device (2) for a towed vehicle (1), wherein the connecting device (2) has at least the following: a first connection device (4) for receiving brake control signals (S3) from a tractive unit, and a second connection device (5) for receiving light control signals (S4) from the tractive unit. According to the invention, it is provided that the connecting device (2) has a control device (3) and a bus connection device (8) for a trailer data bus (12) of the towed vehicle (1), wherein the control device (3) receives the signals (S3, S4) which are received by the first connection device (4) and the second connection device (5), and outputs said signals (S3, S4) or signals (S1, S2) which are determined from said signals via the bus connection device (8) to the trailer data bus (12).

The present invention generally relates to a connecting device for a towed vehicle, and to a towed vehicle having such a connecting device.

Towed vehicles for trucks generally have brake systems and light systems or lighting systems which are actuated by the towing vehicle and are supplied with compressed air and current. The connection between the towed vehicle and the towing vehicle can generally be made via coupling heads of the towed vehicle which are connected to the corresponding coupling heads of the towing vehicle (motor vehicle), for example a coupling head in yellow for the pneumatic brake control line, and a coupling head in red for the supply compressed air line. The further cabling in the towed vehicle is generally implemented by laying a single wire for the lighting and a single wire for the brake system, with the result that two lengths of cable are installed separately in the towed vehicle.

ISO standards are basically provided for the connections. For example, ISO 7638 in particular is provided for the design of the connecting plug for the brake system and the electrical brake control signals, and ISO 12098 for the connections for the light system and for the light control signals. In this context, separate ground connections can be provided for these connections in order to comply with the legal braking regulations/ECE R13. Furthermore, earlier connection standards are known, for example 24N/S. In such systems the electric control lines, in particular the lines for the vehicle lighting, are also lead as a single wire through the towed vehicle.

Such an arrangement therefore gives rise to corresponding expenditure on the laying of cables, which also has to be carried out specifically for different towed vehicles in each case.

An object of the present invention is to provide a control system for a towed vehicle that permits comparatively little expenditure on installation.

This object can be achieved by means of a connecting device for a towed vehicle as claimed in claim 1 and a towed vehicle having such a connecting device. The dependent claims describe preferred embodiments of the present invention.

The present invention is based on the idea of providing a connecting device or a connection box which already has an electronic control unit or a control device and also relevant inputs for the light control signals and brake control signals. This connecting device may be used, in particular, directly on the front of the towed vehicle. A vehicle-internal trailer data bus system with the combined connections and lines start from the control device and can extend, in particular, to a brake control device of the brake system, for example, to the brake modulator and to the lighting devices.

In this context, according to a first embodiment of the present invention it is possible to provide a single trailer data bus, i.e. a vehicle-internal data bus, of the towed vehicle, which comprises the control device of the connecting device, the brake control device and the lights or lighting devices of the towed vehicle, and which may comprise further loads, if appropriate. A data bus, which preferably serves directly for actuating lighting devices, therefore starts from the control device.

According to an alternative embodiment, firstly the trailer data bus can start from the control device of the connecting device as a first data bus leading to the brake control device, which itself serves in turn as a modulator from which a further data bus then in turn starts as a trailer light data bus leading to the lighting devices, and if appropriate, further loads. The data which are transmitted via this further data bus can therefore first be transmitted in the first data bus (trailer data bus) to the brake control device and then transmitted from the brake control device via the further data bus or trailer light data bus.

According to an embodiment of the present invention, the trailer data bus can be a CAN bus and the further data bus or trailer light data bus can also be a CAN bus or else a bus according to another standard, for example a LIN bus.

The present invention provides a number of advantages. For example, the entire expenditure on cabling, i.e. both the material expenditure on the cabling and the installation expenditure on the laying of the cabling can be significantly reduced. A high level of flexibility compared to changes of the system can also be achieved by means of the trailer data bus, if appropriate in addition to the trailer light data bus, which changes can occur, for example, when the further loads are connected and for different models or models with varying equipment levels, so that according to the invention a high level of flexibility accompanied by a high level of safety is achieved.

The control device of the connecting device can, according to an embodiment of the present invention, also fulfill further functions, for example simulating the loads using the lighting means for the monitoring of the lamps in the towing vehicle.

The invention will be explained in more detail below by means of a number of exemplary embodiments and with reference to the accompanying drawing, in which:

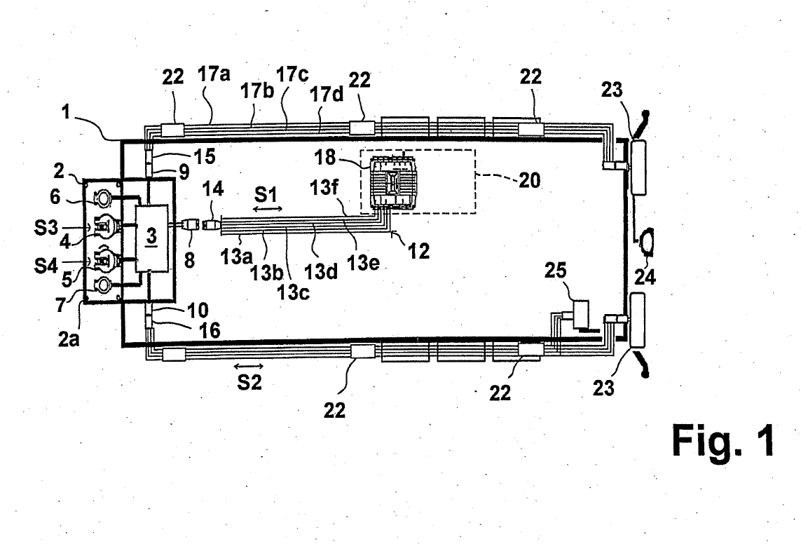

FIG. 1: shows a schematic plan view of a towed vehicle with a control system according to the invention according to first embodiment; and

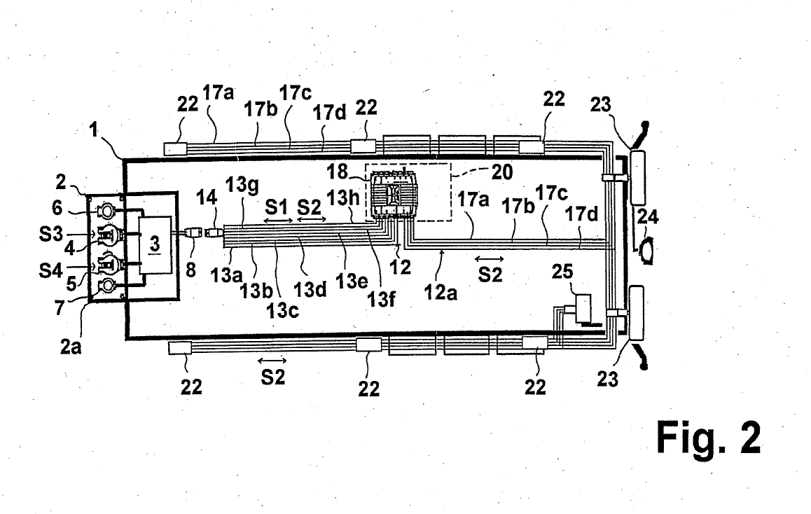

FIG. 2: shows an illustration, corresponding to FIG. 1, of a second embodiment.

A towed vehicle 1 can be embodied, for example, as a semitrailer or as a drawbar vehicle and can connect to a towing vehicle or motor vehicle (not shown here). The towed vehicle 1 has, on its front side shown here on the left, a connecting device 2 which forms a connection box 2 or front box 2. The connecting device 2 can have, according to FIGS. 1 and 2, a housing 2a in which an ECU (control device) 3 can be accommodated. Furthermore, the connecting device 2 can have in or on the housing 2 a first connection apparatus 4 according to ISO 7638 as a connection plug for the brake system or the brake control signals S3, and a second connection apparatus 5 according to ISO 12098 as a connection plug for the light signals S4. Optionally, a third connection apparatus 6 can also be provided as 24N, and a fourth connection apparatus 7 as 24S, wherein these connection apparatuses 6 and 7 can basically also be dispensed with. The connection apparatuses 4, 5, and if appropriate 6, 7, can each be connected to the ECU 3 within the connecting device 2.

According to an embodiment of the present invention an internal data bus system can be formed in the towed vehicle 1. According to FIG. 1, a single trailer data bus 12 is provided. To serve this purpose, the ECU 3 is provided with bus connection plugs 8, 9 and 10 which may be part of the connecting device 2 and, if appropriate, project out of the connecting device 2.

The bus connection plugs 8, 9 and 10 serve for connection to mating plugs 14, 15 and 16 of the internal trailer data bus 12. According to the embodiment in FIG. 1, the trailer data bus 12 serves to connect the ECU 3 both to a brake control device 18 of the brake system 20 (shown here merely as a block) of the towed vehicle 1 and for connecting the various lighting devices 22, 23, 24 of the towed vehicle 1, which may be, in particular side lights 22, brake lights 23 and flashing hazard warning lights 24 indicated only in schematic form here, as well as, if appropriate, lane keeping lights.

The trailer data bus 12 can have, for example, four or six individual data lines 13 a to f between the ECU 3 and the brake control device 18 in order to transmit trailer-internal brake control signals S1. With an embodiment as a CAN data bus, according to ISO 7638 it is therefore possible to provide a first data line 13a for the voltage supply (power), also a ground line 13b and additionally the CAN high data line 13c as well as the CAN low data line 13d. In addition to these four data lines 13 it is optionally also possible to provide a brake light data line 13e and, if appropriate, an additionally accommodated LIN bus 13f, with the result that, as shown, six data lines 13 can be formed between the connecting device 2 and the brake control device 18. The brake control device 18 can therefore also receive the information of the brake light signal (stop light power) transmitted as a light signal S4 in order, when the brake light signal is present, to detect activation of the brake if, under certain circumstances, the first connection apparatus 4 for the brake system is not connected to the towing vehicle.

For example, three or four data lines 17 a to d may be provided between the connecting device 2 and the lighting devices 22, 23 and 24 in order to transmit vehicle-internal light control signals S2 which can, in particular, be transmitted in digital form, wherein each lighting device can be addressed separately. The connecting device 2 with the ECU 3 therefore serves to read in the light control signals S4 input from the towing vehicle via the light socket according to ISO 12098 (or 24N/S), also to receive the brake control signals S1 which can be input via the brake connection apparatus 4, also to conduct through the voltage supply via the bus connection plug 8, to conduct through the brake control signals S3 as CAN signals S1, and also to conduct through the warning lamp line of the ISO 7638 socket to the brake control device 18 or to the brake control unit.

Furthermore, the combined light control signals S4, which have been received via the second connection apparatus 5 according to ISO 12098, can be implemented as internal light control signals S2 via the trailer data bus 12.

According to an embodiment of the present invention, all the lights 22, 23, 24 can be supplied with a common voltage by using a common trailer data bus 12. The actuation of the lights (or lighting devices) 22, 23, 24 can be carried out via the trailer data bus 12 in accordance with the CAN signal according to ISO 12098 via the second connection apparatus 5, and if appropriate also for the actuation of the brake lights 23 via the corresponding CAN signal according to ISO 7638.

A further advantage is that all the relevant data, for example also a starting aid request, air shaft request etc. can be transmitted to the brake control device 18.

According to an embodiment of the invention it is furthermore also possible for the lights 22, 23, 24 to be controlled by the brake control device 18, serving as a modulator, via the trailer data bus 12, for example at the request of a driver assistance system.

A simulation of the loads or loading by the lights 22, 23, 24 for monitoring the lamps can also take place in the towing vehicle and be correspondingly transmitted to the ECU 3 via control signals.

Further trailer components 25 such as, for example, air shaft valves or RTR valves can also be actuated by means of the trailer data bus 12. The internal trailer data bus 12 can also thus be extendable for further functions.

FIG. 2 shows a further embodiment in which the connecting device 2 is basically embodied in a similar or identical way to that in FIG. 1. However, the ECU (control device) 3 merely has the bus connection plug 8 for the trailer data bus 12 leading to the brake control device 18 of the brake system 20, not shown in more detail. Both the brake control signals S1 and the light control signals S2 are therefore firstly output from the ECU 3 to the brake control device 18 via the vehicle bus 12, preferably via the CAN high data line 13c and the CAN low data line 13d. Furthermore, a trailer light data bus 12a is connected to the brake control device 18, via which trailer light data bus 12a the light control signals S2 are transmitted to the lights 22, 23, 24. The brake control device 18 therefore serves as a modulator for receiving and transmitting the light control signals S2 and, if appropriate, further signals to loads 25 and from the lights 22, 23, 24 back to the ECU 3.

The data line 30 which is used for the trailer light data bus 12a can therefore have, for example, six or eight individual lines 13a to 13g in FIG. 2, for example the lines 13a to 13f for the transmission of data according to ISO 7638 as in FIG. 1, as well as a supply voltage connection 13g according to ISO 12098 (power ISO 12098) as well as a ground connection 13h according to ISO 12098 (ground ISO 12098). The data line of the trailer data bus 12a can have, according to FIG. 1, three or four data lines 17a to 17d for transmitting the light control signals S2.

1. A connecting device (2) for a towed vehicle (1), wherein the connecting device (2) has at least: a first connection apparatus (4) for receiving brake control signals (S3) from a towing vehicle, and a second connection apparatus (5) for receiving light control signals (S4) from the towing vehicle, characterized in that the connecting device (2) has a control device (3) and a bus connection apparatus (8) for a trailer data bus (12) of the towed vehicle (1), wherein the control device (3) receives the signals (S3, S4) received by the first connection apparatus (4) and the second connection apparatus (5) and outputs these signals (S3, S4) or signals (S1, S2) determined on the basis of these signals to the trailer data bus (12) via the bus connection apparatus (8).

2. The connecting device (2) as claimed in claim 1, characterized in that it has a housing (2a) for mounting in a front region of the towed vehicle (1), wherein the control device (3) is accommodated in the housing (2a), and the connection apparatuses (4, 5) are accommodated in or on the housing (2a).

3. The connecting device (2) as claimed in claim 1 or 2, characterized in that the first connection apparatus (4) is embodied according to ISO 7638 and the second connection apparatus (5) is embodied according to ISO 12098 and/or ISO 11992, wherein the control device (3) receives brake light signals (S4) received via the second connection apparatus (5), and said control device (3) outputs, as a function thereof, a brake control signal (S1) to the brake control device (18) on the trailer data bus (12).

4. The connecting device (2) as claimed in one of the preceding claims, characterized in that the control device (3) is connected via its bus connection apparatus (8) and the trailer data bus (12) to a brake control device (18) of the towed vehicle (1).

5. The connecting device as claimed in claim 4, characterized in that the control device (3) is only connected to the brake control device (18) via its bus connection apparatus (8) and outputs both the brake control signals (S1) and the light control signals (S2) to the brake control device (18).

6. The connecting device as claimed in claim 4, characterized in that the control apparatus (3) is also connected to lighting devices (22, 23, 24) of the towed vehicle via the trailer data bus (12), and outputs light control signals (S2) directly to the lighting devices (22, 23, 24) via the trailer data bus (12; 12b).

7. The connecting device (2) as claimed in one of the preceding claims, characterized in that the control device (3) simulates the loads by means of the lighting devices (22, 23, 24) of the towed vehicle (1) for the monitoring of lamps in the towing vehicle.

8. A towed vehicle (1) which has: a connecting device (2) as claimed in one of the preceding claims, a brake system (20) having a brake control device (18), lighting devices (22, 23, 24) and a trailer data bus system (12, 12a) to which the control device (3) of the connecting device (2), the brake control device (18) and the lighting devices (22, 23, 24) are connected for the bidirectional transmission of data, wherein brake control signals (S1) and light control signals (S2) are output to the brake control device (18) and the lighting devices (22, 23, 24) by the control device (3) of the connecting device (2).

9. The towed vehicle (1) as claimed in claim 8, characterized in that a single trailer data bus (12) is provided as the trailer data bus system (12), to which trailer data bus (12) the brake control device (18), the lighting devices (22, 23, 24) and the control device (3) of the connecting device (2) are connected.

10. The towed vehicle (1) as claimed in claim 9, characterized in that the trailer data bus system (12) has a trailer data bus (12) and a trailer light data bus (12a), wherein the control device (3) of the connecting device (2) and the brake control device (18) are connected to the trailer data bus (12), and the brake control device (18) and the lighting devices (22, 23, 24) are connected to the trailer light data bus (12a) and the brake control device (18) receives light control signals (S2) from the control device (3) via the trailer data bus (12) and passes them on via the trailer light data bus (12a).

11. The towed vehicle (1) as claimed in claim 10, characterized in that the trailer data bus (12) is embodied as a CAN data bus and separate lines (13a, 13b, 13g, 13h) for the voltage supply and ground, respectively, according to both ISO 7638 and ISO 12098,
wherein the brake control signals (S1) and the light control signals (S2) are transmitted via the CAN high data line (13c) and CAN low data line (13d), and
wherein the brake control device (18) connects through the voltage supply and ground for the lighting devices (22, 23, 24) from the trailer data bus (12) to the trailer light data bus (12a).
